(19) United States
(12) Patent Application Publication
(10) Pub. No.: US 2019/0211140 A1
(43) Pub. Date: Jul. 11, 2019

(54) LIGHT-FIXABLE CASTING COMPOSITION AND METHOD OF SELECTIVELY CASTING SUBSTRATES/COMPONENTS USING THE COMPOSITIONS

(71) Applicant: DELO Industrie Klebstoffe GmbH & Co. KGaA, Windach (DE)

(72) Inventors: Moritz REICHVILSER, Munchen (DE); Angela STARK, Purgen (DE); Tobias KONIGER, Muhr am See (DE); Ralf KMETH, Kongisbrunn (DE)

(21) Appl. No.: 16/330,666

(22) PCT Filed: Aug. 23, 2017
(86) PCT No.: PCT/EP2017/071202

§ 371 Date: Mar. 5, 2019

(30) Foreign Application Priority Data
Sep. 13, 2016 (DE) 10 2016 117 183.2

(51) Int. Cl. C08G 59/42; C08L 63/00; C08G 59/24; C08G 59/28; C08G 59/62; C09D 163/00; C08G 59/50

(52) U.S. Cl. CPC C08G 59/42; C08L 63/00; C08G 59/245; C08K 5/0025; C08G 59/623; C09D 163/00; C08G 59/508; C08G 59/28

(57) ABSTRACT

The invention relates to heat-curing and light-fixable epoxy-based compositions which are liquid at room temperature, comprising at least one epoxy-containing compound (A) having at least two epoxy groups, at least one curing agent (B) for the epoxy-containing compound, optionally an accelerator (C), at least one radiation-curing compound (D), at least one photoinitiator (E) for radical polymerization and at least one filler (F). The radiation-curing compound (D) comprises at least one at least trifunctional (meth)acrylate. In particular, the epoxy composition can be used for fixing and/or selectively encapsulating electrical, electronic and/or electromechanical components, and/or for bonding, coating and sealing.

### FIELD OF THE INVENTION

The invention relates to a heat-curing and light-fixable epoxy-based composition that is liquid at room temperature, in particular for fixing and/or encapsulating components, and a method of encapsulating components using the composition.

In particular, the present invention relates to heat-curing epoxy resin-based high-reliability compositions and a curing agent comprising, in addition, at least one radiation-curing compound and a photoinitiator for radical polymerization. The compositions according to the present invention can first be fixed by irradiation and subsequently heat-cured. Due to their high contour stability already achieved in the irradiation step, these compositions are particularly suitable for use in fast casting processes. After the heat-curing step the compositions according to the present invention are characterized by high mechanical reliability, a low coefficient of thermal expansion and, in particular, high media resistance. Moreover, the invention relates to a method in which the compositions are used in selective casting applications.

### TECHNICAL BACKGROUND

The curing of epoxy resins by anhydrides has long been known in the state of the art. U.S. Pat. No. 5,189,080 discloses filled compositions based on epoxy resins, anhydrides and an accelerator. High filling levels of amorphous quartz make it possible to achieve low coefficients of thermal expansion in the cured compositions. At the same time, such compositions are characterized by high resistance and a high glass transition point. For these reasons, epoxy compositions cured by anhydrides are preferably used in casting, bonding or coating applications requiring high reliability.

In particular in the field of electronics, low coefficients of thermal expansion are important to keep the tension in the component low in the case of varying thermal loads. Thus, chip casting in the field of performance electronics represents a typical area of application of epoxy compositions cured by anhydrides. DE 19 820 216 A1 describes the use of such systems for, inter alia, heat-curing glob top applications. However, a disadvantage during chip casting applications on circuit boards is that the compositions, after dosing on the respective component and during heat curing, tend to melt away. In particular a high integration density can result in individual components, contacts or wires undesirably coming into contact with the casting composition and, conversely, areas to be protected not being completely covered by the composition.

U.S. Pat. No. 4,732,952 describes compositions based on polyepoxides and (meth)acrylic acid anhydrides and curable in two stages which additionally contain a photoinitiator for radical polymerization. In the respective compositions, first the unsaturated groups can be radical-polymerized by irradiation, resulting in a B stage state in which flowability is restricted. Subsequently, in a second heat-curing step, the remaining epoxy proportion can be cured by the anhydride groups in a polyaddition reaction. However, the (meth)acrylic acid anhydrides described in U.S. Pat. No. 4,732,592 are exclusively bifunctional. For sufficient fixation high proportions of the (meth)acrylate component and long irradiation times are necessary.

WO 2015/094 629 describes epoxy resin compositions containing, apart from the epoxy component, a (meth)acrylate-containing polyol, an initiator for radical polymerization and a curing agent. The described curing agents are selected from the group of amines and anhydrides. The exemplary (meth)acrylate compounds allow for a dual curing of the compositions and, at the same time, serve flexibilization. However, a disadvantage of this approach is that, because the described (meth)acrylates are exclusively bifunctional, high concentrations are necessary for fixation by light, resulting in a phase separation during light-curing. In addition, high proportions of polyol-based (meth)acrylates have a negative effect on the reliability of the compositions during thermal stress and on the resistance to media such as solvents, fuels or lubricants.

U.S. Pat. No. 5,565,499 describes light-fixable, anhydride-curable epoxy resin compositions for use in filament winding. They preferably contain high proportions of unsaturated radiation-curing compounds such as acrylates. During winding the compositions are fixed by irradiation to prevent them from melting away. Due to the high acrylate proportions, the compositions obligatorily contain a peroxide to ensure complete curing of the unsaturated compounds in subsequent heat curing.

It is further known in the state of the art that epoxy resin compositions cured with latent imidazole-based curing agents show a good adhesion even on compositions difficult to join such as LCP (liquid crystal polymer), in particular following temperature and moisture stress. However, these compositions have relatively high coefficients of thermal expansion and are thus not suitable for casting applications in the field of electronics.

For the encapsulation of electronic components, the state of the art encompasses dam and fill processes and glob top castings based on epoxy resin compositions. Besides, molding processes are often used. With the integration density increasing and component geometries becoming increasingly complex, in encapsulation processes, there is the need for applications which, apart from material savings, allow for a selective casting by means of exclusive encapsulation of certain selected components.

US 2007 0 289 129 describes a method in which individual elements or entire assemblies are first surrounded by a dam and then the dam is filled with a fill material. The fill material is cured in a downstream heat-curing step. The process may be performed iteratively using various dam heights. However, the high space requirement of different dam structures on one circuit board is disadvantageous. To this end, when designing the board, areas have to be kept clear, which substantially limits the functional and spatial design possibilities and achievable integration densities. Moreover, in the case of a high assembly density, there may be an undesired wetting of components with the casting composition.

DE 10 2014 105 961 describes a method of height-selectively casting electronic components onto circuit boards. To this end, first a dam is formed around the desired component by means of a light-curing material. In a second step, the dam is filled with a casting material under reduced pressure and cured in another heat-curing step. A disadvantage of this method is the use of two different materials for height-selective casting. Typically, UV-curing compositions based on (meth)acrylates do not achieve a high resistance upon permanent exposure to temperature and moisture. In addition, combining incompatible compositions during thermal stress may lead to varying expansion of the dam and fill material, thus creating tensions on the component which could result in thin bond wires breaking away.

### SUMMARY OF THE INVENTION

The object of the present invention is to provide heat-curing epoxy resin systems for selective casting applications which can be reliably processed and remain dimensionally stable during curing. In addition, the cured compositions are supposed to have a high mechanical reliability, a low coefficient of thermal expansion and in particular a high resistance.

The object is solved by heat-curing and light-fixable epoxy-based compositions which are liquid at room temperature, comprising at least one epoxy-containing compound (A) having at least two epoxy groups, at least one curing agent (B) for the epoxy-containing compound, optionally an accelerator (C), at least one radiation-curing compound (D), at least one photoinitiator (E) for radical polymerization and at least one filler (F). The radiation-curing compound (D) comprises at least one at least trifunctional (meth)acrylate.

Compositions in which the at least one epoxy-containing compound (A) makes up the major proportion of the curable components (A) and (D) of the composition are referred to as epoxy-based compositions. That is, the epoxy-containing compound is present in an amount that is larger than the amount of the radiation-curing component (D). The use of an at least trifunctional (meth)acrylate as component (D) in conjunction with the photoinitiator (E) in epoxy-based compositions allows for the compositions, after application onto a substrate, to be fixed, within a short time, by irradiation into a state in which the irradiated compositions remain dimensionally stable even when heated to high temperatures and no melting away occurs. The actual curing of the epoxy resin component is performed in the heat-curing step. Properties such as high mechanical reliability, low coefficients of thermal expansion and high resistance are generated only by heat curing. The use of an at least trifunctional (meth)acrylate allows for faster fixing times and, at the same time, low mass fractions of the radiation-curing component (D). Thus, the presence of the radiation-curing component (D) in the compositions according to the present invention does not have a negative effect on the high reliability of the epoxy composition, as component (D) is used only at low concentrations.

### DESCRIPTION OF PREFERRED EMBODIMENTS

In the following, the invention is described in detail and by way of example by means of preferred embodiments, which, however, are not to be understood as limiting.

According to the invention, epoxy-based compositions which are liquid at room temperature are provided comprising at least one epoxy-containing compound (A), at least one curing agent (B), optionally an accelerator (C), at least one radiation-curing compound (D), a photoinitiator (E) for radical polymerization and at least one filler (F). In addition, further additives (G) may be contained in the compositions.

The compositions according to the present invention can be formulated, depending on process- and application-specific requirements, both as one-part compositions and two- or multi-part compositions.

“One-part” or “one-part composition” means that the components named are present together in a joint formulation, i.e they are not stored separately. In the case of two-part formulations in particular the epoxy component (A) and the reactive curing component (B) are separated and only combined and mixed when processing the composition.

Two-part compositions have advantages, in particular when consumption is high, and are further characterized by an increased storage stability at room temperature.

The composition of the individual components (A) to (G) of the compositions according to the present invention is explained in detail below. The substances used for components (A) to (G) can be selected from the compositions named and combined with each other without any limitation.

Component (A): Epoxy-Containing Compound

The epoxy-containing compound (A) in the compositions according to the present invention comprises at least one at least bifunctional epoxy-containing compound. At least “bifunctional” means that the epoxy-containing compound contains at least two epoxy groups. For example, component (A) can comprise cycloaliphatic epoxides, aromatic and aliphatic glycidyl ethers, glycidyl esters or glycidyl amines and mixtures thereof.

Bifunctional cycloaliphatic epoxy resins are known in the state of the art and contain compounds bearing both a cycloaliphatic group and a least two oxirane rings. Exemplary agents are 3-cyclohexenylmethyl-3-cyclohexylcarboxylate diepoxide, 3,4-epoxycyclohexylalkyl-3′,4′-epoxycyclohexane carboxylate, 3,4-epoxy-6-methylcyclohexylmethyl-3′,4′-epoxy-6-epoxycyclohexane carboxylate, vinylcyclohexene dioxide, bis(3,4-epoxycyclohexylmethyl)adipate, dicyclopentadiene dioxide, 1,2-epoxy-6-(2,3-epoxypropoxy)hexahydro-4,7-methane indane. Preferably, 3,4-epoxycyclohexylmethyl-3′,4′-epoxycyclohexyl carboxylate is used.

Aromatic epoxy resins can also be used in the compositions according to the present invention. Examples of aromatic epoxy resins are bisphenol-A epoxy resins, bisphenol-F epoxy resins, phenol novolac epoxy resins, cresol novolac epoxy resins, biphenyl epoxy resins, 4,4′-biphenyl epoxy resins, divinylbenzene dioxide, 2-glycidyl phenylglycidyl ether, naphthalene diol diglycidyl ether, glycidyl ether of tris(hydroxyphenyl)methane, glycidyl ether of tris(hydroxyphenyl)ethane. In addition, all completely or partially hydrogenated analogues of aromatic epoxy resins can be used.

Isocyanurates substituted with epoxy-containing groups and other heterocyclic compounds can also be used in the compositions according to the present invention. Examples are triglycidyl isocyanurate and monoallyldiglycidyl isocyanurate.

Moreover, higher-functional epoxy resins of all resin groups named, impact-resistant elasticized epoxy resins and mixtures of various epoxy resins can also be used in the compositions according to the present invention.

A combination of several epoxy-containing compounds at least one of which is bi- or higher-functional is also in the sense of the invention.

Examples of commercially available epoxy-containing compounds (A) are available under the trade names CELLOXIDE™ 2021P, CELLOXIDE™ 8000 from Daicel Corporation, Japan, or EPIKOTE™ RESIN 828 LVEL, EPIKOTE™ RESIN 166, EPIKOTE™ RESIN 169 from Momentive Specialty Chemicals B.V., the Netherlands, or Epilox™ resins of the product series A, T, and AF from Leuna Harze, Germany, or EPICLON™ 840, 840-S, 850, 850-S, EXA850CRP, 850-LC from DIC K.K., Japan.

In the compositions according to the present invention component (A) is preferably present in a proportion of 2-60 weight percent, more preferably 4-30 weight percent and particularly preferably 5-20 weight percent, based on the total weight of the composition.

Component (B): Curing Agent

The curing agent (B) preferably comprises at least one compound selected from the group consisting of carboxylic acid anhydrides, nitrogen-containing compounds, compounds having two or more phenolic hydroxyl groups and aminophenols and mixtures thereof. Preferably, the curing agent comprises a carboxylic acid anhydride.

The carboxylic acid anhydride is preferably an anhydride of a poly-proton carboxylic acid and not particularly restricted as long as it has at least one anhydride group.

Particularly preferably, the curing agent (B) comprises at least one carboxylic acid anhydride selected from the group consisting of the anhydrides of two-proton carboxylic acids and aromatic four-proton carboxylic acids and mixtures thereof.

Specific examples of anhydrides which can be used as a curing agent in the present compositions comprise the anhydrides of two-proton acids such as phthalic acid anhydride (PSA), succinic acid anhydride, octenyl succinic acid anhydride (OSA), pentadodecenyl succinic acid anhydride and other alkenyl succinic acid anhydrides, maleic acid anhydride (MA), itaconic acid anhydride (ISA), tetrahydrophthalic acid anhydride (THPA), hexahydrophthalic acid anhydride (HHPA), methyltetrahydrophthalic acid anhydride (MTHPA), methylhexahydrophthalic acid anhydride (MHHPA), nadic acid anhydride, 3-6-endomethylene tetrahydrophthalic acid anhydride, methylendomethylene tetrahydrophthalic acid anhydride (METH, NMA), tetrabromine phthalic acid anhydride and trimellitic acid anhydride as well as the anhydrides of aromatic four-proton acids such as biphenyl tetracarboxylic acid anhydrides, naphthalene tetracarboxylic acid anhydrides, diphenylether tetracarboxylic acid anhydrides, butane tetracarboxylic acid anhydrides, cyclopentane tetracarboxylic acid anhydrides, pyromellitic acid anhydrides and benzophenone tetracarboxylic acid anhydrides. These compounds can be used alone or in combination of two or more thereof.

Among these anhydrides preferably compounds which are liquid at room temperature such as methylhexahydrophthalic acid anhydride (MHHPA), methyltetrahydrophthalic acid anhydride (MTHPA), methylendomethylene tetrahydrophthalic acid anhydride (METH, NMA) and their hydrogenation products are used as curing agents.

The preferred anhydrides for use as the curing agent (B) are, for example, commercially available under the following trade names: MHHPS, for examples, under the trade names HN-5500 (Hitachi Chemical Co., Ltd.) and MHHPA (Dixie Chemical Company, Inc.); METH under the trade names NMA (Dixie Chemical Corporation, Inc.), METH/ES (Polynt S.p.A.) and MHAC (Hitachi Chemical Co., Ltd.)

In addition, nitrogen-containing compounds, compounds having two or more phenolic hydroxyl groups or aminophenols known as curing agents for epoxy compositions can be used as the curing agent (B) for the epoxy resin component (A).

Examples of suitable nitrogen-containing compounds comprise amines, particularly aliphatic polyamines, arylaliphatic polyamines, cycloaliphatic polyamines, aromatic polyamines and heterocyclic polyamines, as well as imidazoles, cyanamides, polyureas, Mannich bases, polyether polyamines, polyaminoamides, phenylkamines, sulfonamides, aminocarboxylic acids or combinations of the substance classes named. Reaction products of epoxides and/or anhydrides and the above-mentioned nitrogen-containing compounds can also be used as the curing agent (B).

Suitable compounds having more than one phenolic hydroxyl group per molecule which can be used as the curing agent (B) comprise phenolic novolacs or resols, generally condensation products of aldehydes (preferably formaldehyde and acetaldehyde) with phenols, cresol novolacs and biphenoldiols. Moreover, the reaction products of biphenols with novolac-type epoxy resins are also suitable as a curing agent.

The curing agent (B) preferably comprises at least one of the above-mentioned anhydrides and optionally one of the nitrogen-containing compounds, phenolic compounds and/or aminophenols named. Preferably, the curing agent (B) is consists of at least 70 weight percent of the anhydride, preferably at least 80 weight percent or at least 90 weight percent.

Particularly preferably, the curing agent (B) completely consists of one of the above-mentioned anhydrides.

In the compositions according to the present invention the curing component (B) is preferably present in a proportion of 2-60 weight percent, more preferably 4-30 weight percent and particularly preferably 5-20 weight percent, each based on the total weight of the composition.

Component (C): Accelerator

The compositions according to the present invention can optionally contain an accelerator (C), which can be selected from all substances commercially available or described in the literature for the acceleration or catalysis of the polyaddition between epoxides and a curing agent. The substance classes of the aliphatic amines, aromatic amines, polyetheramines, (substituted) imidazoles, epoxy imidazole adducts, imidazolium salts, metal complexes, carboxylic acid salts, phosphonium salts, salts of primary, secondary or tertiary amines, ammonium salts, piperidines and their salts, pyridines and their salts, phosphoric and phosphonic acid esters, phosphanes, phosphane oxides, phosphites, phosphinates and other organophosphorus compounds, annelated amidine bases (such as diazabicycloundecene or diazabicyclononene) and their salts are named as examples only, without being limited to the substances named.

Preferably, substituted imidazoles or phosphonium salts are used as the accelerator (C) for anhydride curing. For example, the latter ones are commercially available under the trade names Curezol™ 2MZ-H, C11Z, C17Z, 1.2DMZ, 2E4MZ, 2PZ-PW, 2P4MZ, 1B2MZ, 1B2PZ, 2MZ-CN, C11Z-CN, 2E4MZ-CN, 2PZ-CN, Cl 1Z-CNS, 2PZCNS-PW, 2MZA-PW, Cl 1Z-A, 2E4MZ-A, 2MA-OK, 2PZ-OK, 2PZ-PW, 2P4MHZ, TBZ, SFZ, 2PZL-T from Shikoku Chemicals Corp., Japan. Phosphonium salts such as tetraphenylphosphonium tetraphenylborate, tetrabutylphosphonium-p-toluene sulfonate and others are available from Sigma-Aldrich Chemic GmbH, Germany, or IoLiTec Ionic Liquids Technologies GmbH, Germany.

When using amines as the curing agent (B) preferably substituted ureas such as p-chlorophenyl-N,N-dimethylurea (Monuron), 3,4-dichlorophenyl-N,N-dimethylurea (Diuron) or 3-phenyl-1,1-dimethylurea (Fenuron) can be used as the accelerator (C).

In the compositions according to the present invention component (C) can be present in a proportion of 0-5 weight percent, more preferably 0.02-2.5 weight percent and particularly preferably 0.03-1 weight percent, each based on the total weight of the composition.

Component (D): Radiation-Curing Compound

The radiation-curing compound (D) comprises at least one at least trifunctional (meth)acrylate and is not further restricted with regard to its chemical basic structure (e. g. aromatic, aliphatic, cycloaliphatic). Preferably, the radiation-curing compound (D) comprises at least one at least tetrafunctional (meth)acrylate, particularly preferably at least one at least pentafunctional (meth)acrylate.

The term “(meth)acrylate” and its synonyms signify both here and hereinafter derivatives of acrylic acid as well as methacrylic acid and mixtures thereof.

Commercial, at least trifunctional (meth)acrylates which can be used in the compositions according to the present invention are based, for example, on the (meth)acrylic acid esters of polyhydric alcohols such as glycerol, trimethylolpropane, di-trimethylolpropane, pentaerythritol, dipentaerythritol, tris(hydroxyethyl)isocyanurate or their alkoxylation products, for example by ethoxylation and/or propoxylation of modified alcohols.

Meth(acrylates) derived from polybranched or dendrimeric alcohols can also be used advantageously. In particular, the at least trifunctional (meth)acrylate can comprise a dendrimeric compound having (meth)acrylate groups terminally arranged on a dendrimeric residue. The dendrimeric residue can be a monomeric, oligomeric or polymeric compound, preferably an oligomer or polymer from the group of siloxanes, polyethers, polyesters, polyurethanes and combinations hereof.

Apart from (meth)acrylic acid esters, urethane(meth)acrylates of polyhydric alcohols, (meth)acrylamides of polyvalent amines or epoxy(meth)acrylates can also be used.

Highly functional (meth)acrylates having three or more (meth)acryl residues quickly develop a high crosslinking density when irradiated and thus allow the compositions according to the present invention to be light-fixed even when present in small mass fractions. The small amounts required allow the typical property profile of the cured epoxy resins on which the compositions are based, in particular acid anhydride-cured epoxy resins, to be maintained to a high extent.

Preferred examples of the at least trifunctional (meth)acrylate component comprise trimethylolpropane triacrylate (TMPTA), dipentaerhythritol pentaacrylate (DIPEPA) and dipentaerythritol hexaacrylate (DPTA) and mixtures thereof. They are commercially available from Sartomer under the trade names SR351, SR399 and DPHA.

Preferably, at least tetrafunctional (meth)acrylates are used which can be obtained, for example, from polybranched or dendrimeric polyols such as the Boltorn types H311, P500, P501, P1000, H2004 (all from Perstorp, Sweden), by partial or complete esterification with (meth)acrylic acid or (meth)acrylic acid anhydride or by complete or partial reaction of the branched or dendrimeric polyols to form the corresponding urethane (meth)acrylates. Specific examples of commercially available higher-functional (meth)acrylates comprise the types Viscoat™ 1000 and Viscoat™ 1020 from Osaka Organic Chemical Industry, Japan, Miramer™ SP1108 and SP1106 from Miwon Specialty Chemical Co. Ltd., Korea, and CN2302 and CN2303 from Sartomer Europe, France.

Moreover, apart from the at least one at least trifunctional (meth)acrylate, the radiation-curing compound (D) can also comprise monofunctional and/or bifunctional (meth)acrylates.

Examples of suitable monofunctional (meth)acrylates are isobornyl acrylate, 2-hydroxyethyl acrylate, 4-hydroxybutyl acrylate, stearyl acrylate, tetrahydrofurfuryl acrylate, 2-hydroxy-3-phenoxypropyl acrylate, 2-hydroxypropyl acrylate, cyclohexyl acrylate, 3,3,5-trimethylcyclohexanol acrylate, behenyl acrylate, 2-methoxyethyl acrylate and other mono- or poly-alkoxylated alkyl acrylates, isobutyl acrylate, isooctyl acrylate, lauryl acrylate, tridecyl acrylate, isostearyl acrylate, 2-(o-phenylphenoxy)ethyl acrylate, acryloylmorpholine, N,N-dimethyl acrylamide and other N,N-dialkyl acrylamides, N-alkyl acrylamides, N-alkoxyalkyl acrylamides and otherwise substituted acrylamides. The analogous methacrylates can also be used in the compositions according to the present invention.

Examples of bifunctional acrylates are 1,4-butanediol diacrylate, 1,6-hexanediol diacrylate, 1,10-decanediol diacrylate, tricyclodecane dimethanol diacrylate, dipropylene glycol diacrylate, tripropylene glycol diacrylate and other glycol diacrylates, polybutadiene diacrylate, cyclohexane dimethanol diacrylate, diurethane acrylate of monomeric, oligomeric or polymeric diols and polyols.

Apart from pure (meth)acrylates, the (meth)acrylate-containing compounds of component (D) can also be hybrid molecules having, for example, additionally an epoxy functionality or curing functionality. An example is glycidyl methacrylate.

In the compositions according to the present invention the radiation-curing compound (D) is preferably contained in a proportion of 0.5-5 weight percent, more preferably 4 weight percent, each based on the total weight of the composition. Larger proportions of component (D) can have a negative effect on the coefficient of thermal expansion and thus the reliability of the cured compositions. The duration and temperature of the heat-curing step have to be increased as the proportion of component (D) increases.

The proportion of the at least trifunctional (meth)acrylate of the total weight of the radiation-curing component (D) is at least 50 weight percent. Thus, the at least one trifunctional (meth)acrylate makes up the major proportion of the radiation-curing component (D). If the proportions of the at least trifunctional (meth)acrylate are too low, this may result in disadvantages with regard to the speed or extent of the light fixation.

Particularly preferably, the proportion of the at least trifunctional (meth)acrylate of component (D) is at least 60 weight percent, more preferably at least 70 weight percent, even more preferably at least 80 weight percent or at least 90 weight percent and especially preferably 100 weight percent.

The proportion of the radiation-curing component (D) of the total weight or the organic components (A) to (E) is preferably at most 30 weight percent, more preferably at most 25 or 20 weight cent and particularly preferably at most 15 weight percent.

Component (E): Photoinitiator

Apart from the radiation-curing component (D), the compositions also contain a photoinitiator (E) for radical polymerization. As photoinitiators, the usual, commercially available compounds can be used, for example α-hydroxyketones, benzophenone, α,α-diethoxyacetophenone, 4,4-diethylaminobenzophenone, 2,2-dimethoxy-2-phenylacetophenone, 4-isopropylphenyl-2-hydroxy-2-propylketone, 1-hydroxycyclohexyl phenyl ketone, isoamyl-p-dimethylaminobenzoate, methyl-4-dimethylaminobenzoate, methyl-o-benzoylbenzoate, benzoin, benzoin ethyl ether, benzoin isopropyl ether, benzoin isobutyl ether, 2-hydroxy-2-methyl-1-phenylpropane-1-on, 2-isopropylthioxanthone, dibenzosuberone, 2,4,6-trimethylbenzoyldiphenylphosphine oxide and bisacylphosphine oxides, wherein the photoinitiators named can be used alone or in combination of two or more of the compounds named.

As UV photoinitiators, for example, IRGACURE™ types from BASF SE can be used, for example the IRGACURE 184, IRGACURE 500, IRGACURE 1179, IRGACURE 2959, IRGACURE 745, IRGACURE 651, IRGACURE 369, IRGACURE 907, IRGACURE 1300, IRGACURE 819, IRGACURE 819DW, IRGACURE 2022, IRGACURE 2100, IRGACURE 784, IRGACURE 250, IRGACURE TPO, IRGACURE TPO-L types. In addition, DAROCUR™ types from BASF SE can be used, for example the DAROCUR MBF, DAROCUR 1173, DAROCUR TPO and DAROCUR 4265 types.

The photoinitiator used in the compositions according to the present invention is preferably activatable by actinic radiation of a wavelength ranging from 200 to 500 nm, particularly preferably 320 to 480 nm. If necessary, combination with a suitable sensitizer can be performed.

In the compositions according to the present invention the photoinitiator (E) is typically present in a range from 0.01-5 weight percent, preferably less than 2 weight percent, particularly preferably less than 1 weight percent, based on the mass of the entire formulation.

Component (F): Filler

In addition, the compositions according to the present invention contain at least one filler (F) which influences chemical resistance, media absorption and coefficients of thermal expansion of the compositions according to the present invention. Depending on the required property profile and intended purpose of the compositions according to the present invention different fillers or combinations thereof can be used.

To achieve a low coefficient of thermal expansion usually quartz or quartz glass is used as a filler. Materials having a negative coefficient of thermal expansion (such as zirconium tungstate) can also be used for this purpose.

To achieve a higher thermal conductivity, fillers such as aluminum oxides, aluminum nitride, boron nitride, graphite (also expanded graphite or graphite-based nanotechnology products), carbon nanotubes or metallic fillers can be used.

To achieve an isotropic or anisotropic electrical conductivity metallic fillers or non-metallic fillers coated with electrically conductive layers can be used.

To achieve defined adhesive layer thicknesses so-called spacer particles having narrowly defined particle shapes and particle size distributions can be used as a filler.

With regard to particle shapes (for example angular, spherical, platelet- or needle-shaped) and particle sizes (macroscopic, microscopic, nano-scaled), the selection of fillers is in no way limited. As known, various particle shapes or particle sizes or particle size distributions can be used in combination to achieve, for example, a lower viscosity, a higher maximum filling level or high electrical and thermal conductivity.

Preferably, the filler (F) is selected from the following group: oxides, nitrides, borides, carbides, sulfides and silicides of metals and metalloids, including mixed compounds of several metals and/or metalloids; carbon modifications such as diamond, graphite and carbon nanotubes; silicates and borates of metals and metalloids; all kinds of glasses; metals and metalloids in their elementary form, in the form of alloys or intermetallic phases; inorganic and organic salts insoluble in the resin matrix; and particles from polymeric materials such as silicone, polyamide, polyethylene and PTFE.

A use of mixtures of various fillers (F) is also in the sense of the invention.

In the compositions according to the present invention the filler (F) can be present in a proportion of 1-90 weight percent, preferably 10-80 weight percent, particularly preferably 20-80 weight percent or 40 to 80 weight percent, each based on the total weight of the composition. Epoxy compositions with a high filler content of more than 40 weight percent are particularly suitable for applications requiring high resistance to temperature changes and media resistance.

Component (G): Additives

Optionally, the compositions according to the present invention can contain further additives alone or in combination, including but not being limited to toughness modifiers such as core shell particles or block copolymers, coloring agents, pigments, fluorescent agents, thixotropic agents, thickeners, thermal stabilizers, UV stabilizers, flame retardants, corrosion inhibitors, diluents, levelling and wetting agents or adhesion promoters.

In the compositions according to the present invention the additives (G) are preferably present in a proportion of 0-15 weight percent, preferably 0-10 weight percent, particularly preferably 0-5 weight percent, each based on the total weight of the composition.

The above lists are to be considered as exemplary for components (A) to (G) rather than limiting.

Formulation of the Compositions According to the Present Invention:

A composition according to the present invention consists of the following components:
(A) 2-60 mass fractions of the at least bifunctional epoxy-containing compound;
(B) 2-60 mass fractions of the curing agent for the epoxy-containing compound;
(C) 0-5 mass fractions of the accelerator;
(D) 0.5-5 mass fractions of the radiation-curing compound,
(E) 0.01-5 mass fractions of the photoinitiator;
(F) 1-90 mass fractions of the filler; and
(G) 0-15 mass fractions of the additives,

with the sum of the mass fractions of components (A) to (G) totaling 100.

The radiation-curing compound (D) comprises an at least trifunctional (meth)acrylate, preferably a (meth)acrylate derived from polybranched or dendrimeric polyols.

The proportion of the at least trifunctional (meth)acrylate of the radiation-curing component (D) is preferably 50 to 100 weight percent.

The proportion of the radiation-curing component (D) of the total mass of the organic components (A) to (E) is preferably at most 30 weight percent, more preferably at most 25 or at most 20 weight percent and particularly preferably at most 15 weight percent.

Use of the Compositions According to the Present Invention

a) Light Fixation

The described compositions are fixed by irradiation with light of a wavelength matching the selected photoinitiator. In particular wavelengths between 200 and 500 nm are preferred; wavelengths between 320 and 480 nm are particularly preferred. Irradiation of the composition results in a skin formation on the irradiated surface of the composition that is stable enough to ensure dimensional stability of the composition at the high temperatures used for heat curing.

Penetration depth and thus thickness of the light-fixed layer can be controlled by the irradiation dose, the amount and type of the fillers and additives used and the wavelength used and is typically between 10 μm and 500 μm in the case of black-pigmented compositions and larger than 2 mm for non-pigmented compositions only filled with quartz.

b) Heat Curing

Independently from the type and extent of light fixation, a heat-curing step has to be performed for complete curing of the compositions according to the present invention.

Depending on the curing agent used, the heat-curing step is preferably performed in a temperature range between 60 and 200° C., in the case of anhydrides used as a curing agent preferably at a temperature range from 100 to 180° C.

The energy needed for heat curing can be introduced by convection, for example in a convection oven, by heat conduction, for example by means of a hot plate or thermode, or by electromagnetic radiation, for example by means of IR radiation sources, LASER, microwaves or induction.

Heat curing can be performed in a single- or multi-stage process. Typical curing conditions for anhydride-curable compositions are, for example:
single-stage: 30 min at 150° C.
single-stage: 2 h at 125° C.
multi-stage: 1 h at 100° C., subsequently 30 min at 150° C.

Specific to the application, heat curing of the compositions at higher temperatures or heat curing during other process steps is also possible, for example during a reflow soldering process.

Following light fixation and heat curing, the composition according to the present invention preferably has a coefficient of thermal expansion which, as compared to the coefficient of thermal expansion of a corresponding epoxy composition without components (D) and (E) but with the same filling level, is at most doubled. Thus, the property profile of the composition according to the present invention is almost unchanged as compared to the purely heat-curing epoxy compositions.

After light fixation and heat curing, the composition preferably has a glass transition point Tg of at least 150° C. When used in automotive electronics, such compositions are sufficiently stable with regard to the ambient conditions, in particular when used in the engine compartment.

Furthermore, the composition according to the present invention preferably has a DSC endset temperature which is at most 10° C. above the DSC endset temperature of a corresponding epoxy composition without components (D) and (E) but with the same filling level. In this way, smooth processability of the composition according to the present invention in automated processes can be ensured.

The compositions according to the present invention are characterized in that the cured compositions have a high resistance to various media and environmental impacts. In addition, the cured compositions have a low coefficient of thermal expansion. These properties predestine the compositions to be cast on electronic parts and assemblies. In particular for assemblies exposed to varying thermal loads or media in later operation compositions are required which, over the entire life time of the assembly, remain as stable as possible with regard to their properties and generate few mechanical tensions. These requirements are met by the compositions according to the present invention.

The fact that the compositions can be light-fixed makes it possible, in casting applications on circuit boards and other substrates with complex component geometries, to first select various components and cast them individually, to fix the casting composition across these components by irradiation and then heat-cure all compositions on the substrate in a single final step, thus encapsulating the components. When proceeding like this, fixing of the compositions on the components by irradiation reliably prevents undesired melting away of the casting compositions.

Another object of the invention is a method of selectively encapsulating a component on a substrate in which a substrate having several components is provided; at least one first component is selected from the several components and the composition according to the present invention is dosed onto the first component; and the composition is fixed on the first component by irradiation with actinic radiation and then the fixed composition is heat-cured.

A preferred process sequence consists of the following steps:
a) selectively dosing the composition onto a first component or group of components to form a glob top;
b) fixing the glob top on the first component or group of components by irradiation of the composition;
c) optionally repeating steps a) and b) one or several times on further components or groups of components; and
d) heat-curing the fixed composition.

Here and in all methods described hereinafter, the composition according to the present invention can be dosed by means of all application methods known to those skilled in the art, for example needle dosing, screen print, jetting or vacuum casting.

Fixation by irradiation can be performed using any radiation sources able to release radicals from the photoinitiator (E). Penetration depth of the radiation and thus thickness of the light-fixed layer on the irradiated surface of the composition can be varied by different irradiation times and/or irradiation intensities. Generation of layer thicknesses so thin that they just ensure contour and dimensional stability of the irradiated compositions across the part is preferred.

The sequence of dosing the glob top and fixing it by irradiation can be iteratively repeated for various parts. An advantage of this method is that only a single final heat-curing step is necessary. Due to light fixation, the individual glob tops remain dimensionally stable and no undesired melting away of the composition occurs. Additional heat-curing steps after dosing of the respective glob top can be dispensed with when using the compositions according to the present invention. Moreover, when using this method, prolonged production stops do not have any effect on the quality and precision of the finished cast.

In another preferred embodiment, the application of compositions additionally containing a fluorescent agent as the additive (D) can be optically controlled prior to irradiating the part. This allows detection of dosing errors or, in case of doubt, reprocessing of the part, before further fixing or curing steps are performed. Particularly with expensive circuit boards detection of possible dosing errors is desirable to reduce rejects.

In another embodiment of the methods described above and hereinafter the composition can also be fixed by irradiation using a panel radiator. In this way, several glob tops can be fixed in parallel.

Another embodiment of the method according to the present invention comprises a combination of a glob top cast and a dam and fill process using the compositions according to the present invention. A preferred method of selectively encapsulating one or more components on a substrate comprises the following steps:
a) selectively dosing the composition according to the present invention onto a first component and/or a group of components to form a glob top;
b) fixing the glob top on the first component and/or the group of components by irradiation of the composition;
c) dosing a dam around the first component and/or the group of components to form a cavity surrounded by the dam;
d) filling the cavity with a heat-curing composition;
e) heat-curing the glob top, the dam and the heat-curing composition.

Steps a), b) and c) can also be repeated and, if advantageous, combined in a different sequence. For example, dosing of the dam (step c) can also be performed prior to dosing (step a) or fixation (step b) of the glob top. Moreover, in step c), several glob tops can be dosed and then subjected to joint light fixation (step b).

Dosing of the dam in step c) and/or filling of the cavity in step d) can be performed using the compositions according to the present invention. However, it is also possible, for dosing the dam and/or filling the cavity, to rely on resin compositions known in the state of the art and being commercially available.

The height of the dam dosed in step c) can be freely selected in a wide range and be adapted to the height of various components or groups of components. Stacking of individual dams is also possible when using compositions according to the present invention.

The described method can also be linked with an optical application control by use of a fluorescent agent, coloring agent or pigment.

Optionally, following step d), it is also possible to additionally fix the filled dam by irradiation prior to heat curing in step e). This prevents further melting away of the compositions and allows the circuit board to be freely moved.

Furthermore, it is also conceivable in the case of high dam structures to additionally fix them by irradiation prior to step d) to create a more stable structure. An additional advantage of light fixing the dam structure becomes obvious in final heat curing. The light-fixed dam based on the compositions according to the present invention does not tend to melt away and thus prevents an extensive melting away of the composition, particularly in large encased structures. Thus, potential changes of viscosity of the filler in the initial phase of heat curing do not pose a problem from the process point of view.

The described method using the compositions according to the present invention is primarily suitable for extensive casting and offers the advantage that high components or groups of components can be protected by single glob tops, while a lower casting level above the height of the dam can be selected. Thus, in total, partially more planar casting is possible allowing the casting material to be used in a resource-saving way.

Overall, a higher freedom for design is possible when performing casting processes. The described method is thus an alternative to classical molding processes. The costly use of component-specific molding tools can be dispensed with when using the method according to the present invention.

Particularly preferably, the heat-curing composition used to fill the cavity and the resin composition used to dose the dam are composed of the same materials, preferably of a composition according to the present invention. The use of the same material ensures a uniform property profile of the cured compositions.

According to another preferred embodiment the resin composition used to dose the dam has a higher viscosity than the composition used to fill the cavity. Formulating different viscous variants of the heat-curing composition of step d) and of the dam material can facilitate the dosing process and, for example, improve stability of the dam. Thus, such embodiments are also in the sense of the invention.

Apart from the described casting applications, the compositions according to the present invention are also suitable for bonding, coating and sealing.

Thus, another object of the invention is the use of the composition according to the present invention for fixing and/or selectively encapsulating electrical, electronic and/or electromechanical components, preferably components on circuit boards, as well as for bonding, coating and sealing.

In the following, the invention is further explained by means of preferred exemplary embodiments making reference to the above description. The examples below, however, are not to be understood as limiting.

### Definitions and Test Procedures

### Irradiation

If not stated otherwise, in the following exemplary embodiments, irradiation or exposure is defined as irradiation using an LED lamp DELOLUX 80/400 (nominal wavelength 400 nm) from DELO Industrie Klebstoffe with an intensity of 200±20 mW/cm².

### Room Temperature

Room temperature is defined as 23° C.±2° C.

### Skin Formation

A droplet of the composition to be tested is dosed on a suitable support (non-absorbent, coated papers) and exposed with the intensity and over the respectively stated period of time using a DELOLUX 80/400 (400 nm) lamp. Then, it is tested manually by means of a wire whether thread forming occurs when touching the surface of the droplet or whether a dry skin has already formed.

### Skin Formation Time

To determine skin formation time single droplets of the compositions were dosed on a cardboard and exposed under the following conditions: 0.5 s, 1 s, 2 s, 3 s, 4 s and 5 s, each at 200±20 mW/cm², as well as 0.1 s, 0.5 s, 1 s and 2 s, each at 1000±20 mW/cm². Skin formation time is defined as the time after which, when touching the surface, no thread forming can be observed. Thus, “<0.1 s” means that, after irradiation for 0.1 s with the intensity mentioned, a skin could already be detected.

### Flow Behavior (Draining Test)

A non-absorbent, coated cardboard of a thickness of approximately 1.5 mm and edge lengths of 100 mm×174 mm serves as a specimen.

Parallel to one of the short edges (distance approximately 15 to 30 mm) a start line is marked on the specimen. Above the line droplets of the compositions to be tested of approximately 0.1 g are applied while the cardboard is supported on a horizontal surface. The specimen is kept in this position for 2 min. In the following, the specimen is placed vertically and remains in this position for the predetermined time, with the adhesive, depending on its flowability, covering a more or less extended distance downwards. The test can be performed at room temperature or at an elevated temperature in a convection oven.

After the test time has elapsed the specimen is returned into the horizontal position and the draining path of the adhesive is determined, measuring the distance covered from the start line to the lowest end of the respective flow front. If the composition flows up to the end of the specimen, the flow path up to the end of the cardboard is measured and provided with a “larger than” sign (“>x mm”).

### DSC Measurements

DSC measurements of reactivity and glass transition are performed using a differential scanning calorimeter (DSC) of the DSC 822e or DSC 823e type from Mettler Toledo.

To this end, 16-20 mg of the liquid sample are weighed into an aluminum crucible (40 μL) using a pin, closed with a perforated lid and subjected to a measurement comprising the following segments: (1) isothermal, 0° C., 2 min; (2) dynamic, 0-250° C., 10 K/min; (3) dynamic, 250-0° C., −10 K/min; (4) isothermal, 0° C., 3 min; (5) dynamic, 0-250° C., 20 K/min. The process gas in all segments is air (volume flow 30 mL/min).

The heating segments (2) are evaluated with regard to reactivity and (5) glass transition. Reaction enthalpy is determined by means of a spline curve used as the base line and standardized to the weight of the sample taken, and its amount is expressed as exothermicity. Glass transformation is analyzed using the tangent method.

### TMA Measurements (Coefficient of Thermal Expansion)

A platelet (thickness 2 mm) made of polyoxymethylene (POM) with an oblong hole of a length of approximately 25 mm and a width of 4 mm serves as a mold for the manufacture of the specimen. The mold is supported on a plastic film (biaxially oriented polyester, Hostaphan RN, thickness 75 μm, unilaterally siliconized), filled with the reactive composition without bubble formation and provided with another covering film.

Optionally, the composition in the mold can be light-fixed at this point in time. Irradiation is performed one after the other from both sides and through the covering films.

Heat curing is performed in the pre-heated convection oven at 150° C. for 50 min, wherein the specimen mold including the covering films is clamped, by means of spring clips, between two aluminum plates (each 3 mm thick).

After cooling of the specimen mold the rod-shaped specimen of the cured composition is demolded and a sample of the material of a width of approximately 4 mm, a length of 4 mm and a thickness of 2 mm is separated and deburred by means of an abrasive paper of a grain size of 600 and subjected to the measurement in a thermomechanical analyzer (TMA) from Mettler Toledo (TMA A840e or TMA A841Ee type).

The measurement comprises the following segments: (1) isothermal, 23° C., 5 min; (2) dynamic, 23-240° C., 2 K/min. In all segments, the bearing force is 0.1 N. Heating segment (2) is evaluated.

The mean coefficient of expansion α₁ was evaluated across the temperature range of 30−150° C.

### Manufacturing Examples

To manufacture the compositions according to the present invention first the liquid components are mixed and then the fillers and other solids are incorporated by means of a laboratory agitator, laboratory dissolver or speed mixer (Hauschild) until a homogeneous composition forms.

Comparative examples can be manufactured analogously.

The composition of the compositions according to the present invention and the comparative examples is listed in the tables below. The percentages mean weight percent, each based on the total weight of the composition.

To manufacture the (meth)acrylate-modified compositions described in the following examples commercially available filled anhydride-curing single-component epoxy resin compositions were used to each of which a (meth)acrylate was added. To compensate for a dilution effect of the added radiation-curing component, some additional filler was added so that the filling level remained unchanged as compared to the original epoxy resin composition.

The abbreviations used in the following tables have the following meaning:
GE765: DELOMONOPDX GE765, filled anhydride-cured single-component epoxy resin composition (glob top) from DELO Industrie Klebstoffe GmbH & Co. KGaA
GE725: DELOMONOPDX GE725, filled anhydride-cured single-component epoxy resin composition (fill) from DELO Industrie Klebstoffe GmbH & Co. KGaA
Photoinitiator: TPO-L, BASF SE
Acrylate 1: IBOS (isobornyl acrylate)
Acrylate 2: HDDA (hexanediol diacrylate)
Acrylate 3: TMPTA (trimethylolpropane triacrylate)
Acrylate 4: DIPEPA (dipentaerythritol pentaacrylate)
Filler 1: Silbond FW 61 EST (quartz)

TABLE 1
Variation of acrylate functionality

| | GE765 | Example 1 | Example 2 | | | Example 5 |
|---|---|---|---|---|---|---|
| | (control) | (comparison) | (comparison) | Example 3 | Example 4 | (comparison) |
| GE765 | 100 | 96.06 | 96.06 | 96.06 | 96.06 | 68.79 |

Radiation-curing component (D)

| | | | | | | |
|---|---|---|---|---|---|---|
| Acrylate 1 (IBOA) | — | 1 | — | — | — | 10 |
| Acrylate 2 (HDDA) | — | — | 1 | — | — | — |
| Acrylate 3 (TMPTA) | — | — | — | 1 | — | — |
| Acrylate 4 (DIPEPA) | — | — | — | — | 1 | — |

Photoinitiator (E)

| | | | | | | |
|---|---|---|---|---|---|---|
| Photoinitiator | — | 0.3 | 0.3 | 0.3 | 0.3 | 0.3 |

Filler (F)

| | | | | | | |
|---|---|---|---|---|---|---|
| Filler 1 | — | 2.64 | 2.64 | 2.64 | 2.64 | 20.91 |
| Sum (weight percent) | 100 | 100 | 100 | 100 | 100 | 100 |
| Skin formation (irradiation: | No | No | No | Yes | Yes | Yes |
| 5 s, 200 mW/cm²) | | | | | | |

Table 1 includes examples of the addition of various acrylates and a photoinitiator to a filled anhydride-curing single-component epoxy resin composition commercially available under the designation DELOMONOPDX GE765 from DELO Industrie Klebstoffe GmbH & Co. KGaA. To exclude the dilution effect of the radiation-curing component (D) and the photoinitiator (E), some additional filler was added to the formulations, thus keeping the filling level of the compositions constant as compared to the starting formulation (GE765 with 67 weight percent of filler).

If DELOMONOPDX GE765 is irradiated, no skin is formed. This product does contain neither a radiation-curing component (D) nor a photoinitiator (E). The compositions of comparative examples 1 and 2 contain a monofunctional or bifunctional acrylate and a photoinitiator. No skin formation is observed in these compositions after 5-second irradiation at 200 mW/cm². However, the same amounts of higher-functional acrylates result in a skin formation after 5-second irradiation (examples 3 and 4 according to the present invention). Due to the small proportions of component (D) in the modified compositions, a crosslinking sufficient for forming a skin within the time mentioned can be achieved only by using at least trifunctional (meth)acrylates. When using a lower-functional acrylate to modify the epoxy composition, light fixation is only possible with substantially higher acrylate proportions (comparative example 5). Although such formulations are light-fixable they have an adverse property profile as compared to the original epoxy resin composition (table 2).

TABLE 2
Variation of (meth)acrylate proportion

| | | | | | | Example 5 |
|---|---|---|---|---|---|---|
| | GE765 | Example 6 | Example 7 | Example 8 | Example 9 | (comparison) |
| GE765 | 100 | 96.06 | 90 | 83.94 | 68.79 | 68.79 |
| Acrylate 1 (IBOA) | | | | | | 10 |
| Acrylate 3 (TMPTA) | | | | | | |
| Acrylate 4 (DIPEPA) | | 1 | 3 | 5 | 10 | |
| Photoinitiator | | 0.3 | 0.3 | 0.3 | 0.3 | 0.3 |
| Filler 1 | | 2.64 | 6.7 | 10.76 | 20.91 | 20.91 |
| Sum (weight percent) | 100 | 100 | 100 | 100 | 100 | 100 |

DSC measurements

| | | | | | | |
|---|---|---|---|---|---|---|
| DSC onset (° C.) | 138 | 139 | 139 | 140 | 144 | 146 |
| Onset shift (° C.) | 0 | +1 | +1 | +2 | +6 | +8 |
| DSC peak (° C.) | 161 | 163 | 164 | 165 | 171 | 174 |
| Peak shift(° C.) | 0 | +2 | +3 | +4 | +10 | +13 |
| DSC endset (° C.) | 180 | 182 | 184 | 186 | 195 | 198 |
| Endset shift(° C.) | 0 | +2 | +4 | +6 | +15 | +18 |
| DSC Tg (° C.) | 187 | 184 | 178 | 181 | 184 | 107 |

TMA measurements

| | | | | | | |
|---|---|---|---|---|---|---|
| TMA α1 (ppm/K) | 29 | 36 | 35 | 56 | 67 | 94 |
| with light fixation | | | | | | |
| 30-150° C. | | | | | | |

Table 2 shows the variation of the type and amount of the radiation-curing component (D). Again, DELOMONOPDX GE765 was used as the starting formulation and control. To this material various acrylates and a photoinitiator were added. Again, to compensate for the dilution, quartz was added as the filler (F) to keep the filling level constant.

The formulations of examples 6 to 9, independently from the proportion of the radiation-curing component (D), achieve glass transition temperatures of more than 175° C. Thus, the compositions are suitable for casting applications of electronic components.

The compositions of comparative example 5 and example 9 contain more than 5 weight percent of the radiation-curing component (D) and, in the DSC measurements, show substantial shifts of the onset, peak and endset temperatures towards higher values. In the case of example 9, with 10 weight percent of DIPEPA, the DSC endset temperature already shifts by 15° C. towards a higher temperature. In comparative example 5, with 10 weight percent of monofunctional acrylate, this effect is even more pronounced.

Thus, with the proportion of component (D) increasing, clearly longer heat-curing processes or elevated process temperatures are required for heat curing of the compositions. A shift of the endset temperature by more than 10° C. towards higher temperatures as compared to commercially available compositions can already lead to substantial disadvantages in industrial production.

In addition, the glass transition temperature of the composition of comparative example 5 clearly decreases below 150° C. and is thus already within the typical temperature application range (−40 to +150° C.) of components used in the field of automotive electronics.

Moreover, the coefficient of thermal expansion of the composition of comparative example 5 increases to 2.5 times that of example 6 according to the present invention. In the case of example 9 an acrylate proportion of 10 weight percent already leads to the coefficient of thermal expansion being more than 2 times that of the acrylate-free control formulation GE725. A higher coefficient of thermal expansion can cause an earlier failure of the encapsulated parts under alternating thermal load. Doubling of the coefficient of thermal expansion as compared to the starting formulation is just about acceptable for most of the high-reliability applications.

TABLE 3
Fixation speed at irradiation

| | Example 6 | | Example 7 | | Example 8 | Example 9 |
|---|---|---|---|---|---|---|
| 200 mW/cm² | <3 | s | <1 | s | <0.5 s | <0.5 s |
| 1000 mW/cm² | <0.5 | s | <0.1 | s | <0.1 s | <0.1 s |

Table 3 shows the skin formation times at an irradiation intensity of 200 and 1000 mW/cm₂ determined for examples 6 to 9. A higher radiation intensity or a larger proportion of component (D) reduces the skin formation time and thus allows for a faster fixation of the compositions.

As can be seen from the measured values, even in the case of a very low proportion of component (D) in the compositions according to the present invention, light fixation within fractions of a second is possible.

TABLE 4
Flow behavior with and without light fixation

| | |
|---|---|
| GE725 (control) | Example 10 |

| | | |
|---|---|---|
| GE725 | 100.00 | 98.7 |
| Acrylate 4 (DIPEPA) | — | 1.0 |
| Photoinitiator | — | 0.3 |
| Sum (weight percent) | 100.00 | 100.00 |

Draining tests without exposure

| | | | | |
|---|---|---|---|---|
| RT, 60 min | 25 | mm | 33 | mm |
| 150° C., 30 min | >145 | mm | >145 | mm |

Draining tests after irradiation (5 s, 200 mW/cm²)

| | | | |
|---|---|---|---|
| RT, 60 min | 25 | mm | 0 |
| 150° C., 30 min | >145 | mm | 0 |

Table 4 shows, as a comparative example, the flow behavior of a commercially available casting composition (DELOMONOPDX GE725, DELO Industrie Klebstoffe GmbH & Co. KGaA) at room temperature and during heat curing in a convection oven at 150° C. for 30 min. Irrespective of whether or not an exposure to actinic radiation occurs, melting away of the compositions is noticeable at room temperature, and is substantial during heat curing. Example 10 according to the present invention in which a low amount (1.0 weight percent) of a pentafunctional acrylate and a photoinitiator were added to the commercially available composition does not show a melting away in the draining test, neither at room temperature nor under the conditions of heat curing (150° C.).

Thus, the skin formed by irradiation at room temperature offers sufficient strength to maintain the contour of the casting composition thus frozen even under the conditions of heat curing.

1. A heat-curing and light-fixable epoxy-based composition which is liquid at room temperature, in particular for the fixation and/or encapsulation of electrical and electronic parts on a substrate, comprising at least one epoxy-containing compound (A) having at least two epoxy groups;
at least one curing agent (B) for the epoxy-containing compound;
optionally an accelerator (C);
at least one radiation-curing compound (D);
at least one photoinitiator (E) for radical polymerization;
at least one filler (F); and
optionally further additives (G);
wherein the radiation-curing compound (D) comprises at least one at least trifunctional (meth)acrylate.

2. The composition according to claim 1, wherein the radiation-curing compound (D) is present in a proportion of at most 5 weight percent, based on the total weight of the composition, and/or in a proportion of at most 30 weight percent, based on the sum of the weight proportions of components (A) to (E).

3. The composition according to claim 1, wherein the radiation-curing compound (D) is present in a proportion of at most 25 weight percent, based on the sum of the weight proportions of components (A) to (E).

4. The composition according to claim 1, wherein the composition contains the radiation-curing compound (D) in a proportion of 0.5-5 weight percent.

5. The composition according to claim 1, wherein the proportion of the at least trifunctional (meth)acrylate of the total weight of the radiation-curing compound (D) is at least 50 weight percent.

6. The composition according to claim 1, wherein the epoxy-containing compound is selected from the group of cycloaliphatic epoxides, aromatic and aliphatic glycidyl ethers, glycidyl esters and glycidyl amines and mixtures thereof.

7. The composition according to claim 1, wherein the curing agent (B) comprises at least one compound selected from the group consisting of carboxylic acid anhydrides, nitrogen-containing compounds, compounds having two or more phenolic hydroxyl groups and aminophenols, and mixtures thereof.

8. The composition according to claim 1, wherein the curing agent (B) comprises at least one carboxylic acid anhydride.

9. The composition according to claim 1, wherein the composition contains the carboxylic acid anhydride in a proportion of 2-60 weight percent, based on the total weight of the composition.

10. The composition according to claim 1, wherein the at least trifunctional (meth)acrylate comprises a (meth)acrylic acid ester of at least trihydric alcohols, or alkoxylated derivatives thereof.

11. The composition according to claim 1, wherein the at least trifunctional (meth)acrylate comprises a dendrimeric compound having (meth)acrylate groups terminally arranged on a dendrimeric residue and/or a polybranched (meth)acrylate-containing compound.

12. The composition according to claim 1, wherein the at least trifunctional (meth)acrylate comprises a urethane (meth)acrylate of a polyhydric alcohol, a (meth)acrylamide of a polyvalent amine or an epoxy(meth)acrylate.

13. The composition according to claim 1, wherein the photoinitiator is activatable by actinic radiation of a wavelengths ranging from 200 to 500 nm and is present in a proportion of 0.01-5 weight percent, based on the total weight of the composition.

14. The composition according to claim 1, comprising or consisting of
(A) 2-60 mass fractions of the at least bifunctional epoxy-containing compound;
(B) 2-60 mass fractions of the curing agent for the epoxy-containing compound;
(C) 0-5 mass fractions of the accelerator;
(D) 0.5-5 mass fractions of the radiation-curing compound (D) comprising at least one at least trifunctional (meth)acrylate;
(E) 0.01-5 mass fractions of the photoinitiator;
(F) 1-90 mass fractions of the at least one filler;
(G) 0-15 mass fractions of one or more additives;
with the sum of all mass fractions totaling 100.

15. The composition according to claim 1, wherein the composition is formulated as a one-part composition or as a two-part composition.

16. The composition according to claim 1, wherein the composition has a coefficient of thermal expansion which, as compared to the coefficient of thermal expansion of a corresponding composition without components (D) and (E) but with the same filling level, is at most doubled.

17. The composition according to claim 1, wherein the composition has a glass transition point Tg of least 150° C.

18. The composition according to claim 1, wherein the composition has a DSC endset temperature which is at most 10° C. above the DSC endset temperature of a corresponding composition without components (D) and (E) but with the same filling level.

19. A method of fixing and/or selectively encapsulating an electrical, electronic and/or electromechanical component, and/or for bonding, coating and sealing of a component, comprising the step of applying the composition of claim 1 to said component.

20. A method of selectively encapsulating a component on a substrate, wherein
a substrate having several components is provided;
at least a first component is selected from the several components and the composition according to claim 1 is dosed on the first component;
the composition dosed on the first component is fixed by irradiation with actinic radiation and the fixed composition is then heat-cured.

21. The method according to claim 20, comprising the following steps:
a) selectively dosing the composition on the first component;
b) fixing the composition on the first component by irradiation of the composition;
c) selectively dosing the composition onto a second component;
d) fixing the composition on the second component by irradiation of the composition;
e) optionally repeating steps c) and d) on further selected components; and
f) subsequently heat-curing the fixed composition.

22. The method of selectively encapsulating one or more components on a substrate according to claim 20, comprising the following steps:
a) dosing said composition to a first selected component and/or a group of components;
b) fixing the composition on the first selected component and/or the group of components by irradiation of the composition;
c) dosing a dam around the first component and/or a group of components to form a cavity surrounded by the dam;
d) filling the cavity with a heat-curing composition;
e) heat-curing the composition, the dam and the heat-curing composition.

23. The method according to claim 22, wherein said composition is used to dose the dam and/or fill the cavity, and that the dam, prior to step d), and/or the heat-curing composition in the cavity, after step d), are fixed by irradiation.

24. The composition according to claim 1, wherein the epoxy-containing compound is present in a proportion of 2-60 weight percent.

25. The composition according to claim 1, wherein the curing agent (B) comprises at least one carboxylic acid anhydride selected from the group consisting of methylhexahydrophthalic acid anhydride (MHHPA), methylendomethylene tetrahydrophthalic acid anhydride (METH, NMA) and hydrogenated methylendomethylene tetrahydrophthalic acid anhydride.

26. The composition according to claim 1, wherein the at least trifunctional (meth)acrylate comprises a (meth)acrylic acid ester of glycerol, trimethylolpropane, di-trimethylolpropane, pentaerythritol, dipentaerythritol, tris(hydroxyethyl)isocyanurate or alkoxylated derivatives thereof.
